(19) United States
(12) Patent Application Publication
(10) Pub. No.: US 2026/0336438 A1
(43) Pub. Date: Oct. 29, 2026

(54) CHARGING DEVICE

(71) Applicant: Stemmann-Technik GmbH, Schüttorf (DE)

(72) Inventors: Marcel Völker, Uelsen (DE); Martin Brinker, Meppen (DE); Dirk Holke, Bad Bentheim (DE)

(73) Assignee: Stemmann-Technik GmbH, Schüttorf (DE)

(21) Appl. No.: 19/120,467

(22) PCT Filed: Oct. 5, 2023
(86) PCT No.: PCT/DE2023/100738

§ 371 Date: Apr. 11, 2025

(30) Foreign Application Priority Data
Oct. 11, 2022 (DE) 10 2022 126 375.4

(51) Int. Cl. B60L 53/16

(52) U.S. Cl. CPC B60L 53/16

(57) ABSTRACT

Charging device for electric vehicles having a rocker 2 which is movable relative to electrical contact surfaces 3, 4 on an upper side of the vehicle 1, wherein the rocker 2 has a central upright rocker support 6 in a central vertical plane V with a rocker beam bearing 8, on which a rocker beam 7 is mounted so as to be rotatable in a horizontal plane, which has two rocker levers 9, 10 on opposite sides of the vertical plane V, wherein contact rail supports 11, 12 are mounted on each rocker lever 9, 10 via upper pivot bearings 13, 14 which are rotatable in a horizontal plane, wherein the contact rail supports 11, 12 each carry contact rails 15, 16, wherein the contact rail supports 11, 12 are guided via guide members 17, 18 relative to the rocker support 6, which are rotatably connected in a horizontal plane to the rocker support 6 via an inner guide member bearing 24, 25 on the one hand and to the contact rail support 11, 12 via a lower pivot bearing 19, 20 on the other hand, wherein a distance between an upper pivot bearing 13, 14 and a lower pivot bearing 19, 20 of a contact rail support 11, 12 is greater than a distance between the rocker beam bearing 8 and each of the guide member bearings 24, 25.

The invention relates to a charging device for electric vehicles with a rocker which is movable relative to electrical contact surfaces on the upper side of the vehicle.

EP 3 568 313 B1 discloses a generic charging device with a contact unit for a charging station of an electrically powered vehicle, in particular for electric buses or the like. The contact unit is arranged above a vehicle for charging. By means of the contact unit, electrical charging contacts of the contact unit can be moved relative to contact surfaces of the vehicle and can be contacted therewith. The contact unit has at least two charging contact supports, each with at least two charging contacts arranged thereon. The charging contact supports are connected to each other via a parallel linkage of the contact unit with two parallel connecting rods and with two parallel support rods. The support rods are connected to the connecting rods in respective one of two parallel planes of movement via spaced-apart connecting joints. They form a parallelogram with the connecting rods. The connecting rods are connected to a base support of the contact unit via two spaced-apart support joints in a support plane running parallel and centered to the planes of movement. The charging contact supports are each connected to the support rod via a pivot joint. The pivot joints are arranged orthogonally relative to the connecting joints. The charging contact supports each hold the charging contacts coaxially relative to the axis of rotation. The contact force on the contact surfaces should be kept as constant as possible. This is to be achieved by means of a double rocker in the form of a parallelogram.

Such charging devices can also be used for charging watercraft, especially ferries. However, large rolling movements occur in watercraft. This particularly concerns rolling movements in the direction of travel, which can also occur in a similar way in land vehicles, such as buses that are lowered on one side to make it easier to get on and off.

The electrical contact surfaces on the upper side of the vehicle are arranged at a certain distance from the vehicle roof so that a charging device does not touch the upper side of the vehicle even if the vehicle performs a certain rolling movement. Since the vehicle is not always positioned exactly below the charging station and may also move slightly sideways, the contact rails of the charging device must have a certain length in order to compensate for these lateral deviations. However, the longer the contact rails of the charging device are, the greater the risk that the ends of the contact rails will be below a minimum distance from the roof or even touch the roof. Installing the roof-side contact surfaces at a greater distance from the roof is usually not an option because this increases the overall height of the vehicle.

The invention is based on the object of providing a charging device for electric vehicles in which the risk of undesirable contact of the charging device with the roof of the vehicle is reduced when the vehicle performs a rolling movement.

This object is achieved in a charging device for electric vehicles with the features of claim 1. The invention is advantageously further developed in the dependent claims.

The charging device for electric vehicles according to the invention has a rocker which is movable relative to electrical contact surfaces on the upper side of the vehicle. The charging device itself can be part of a fixed charging station to which the electric vehicle, such as a land or water vehicle, is brought. The charging device can also be designed in such a way that it is brought close to the electric vehicle or can be moved to the desired position relative to the vehicle. For this purpose, the charging device can be guided on rails or can be brought close to the electric vehicle without being tied to rails. The charging device is used to transmit electrical energy, in particular to charge vehicle's electrical storage devices, for example when a bus stops at a bus stop or is in the depot or when ships are moored at a jetty. For this purpose, the charging device is connected to an electrical supply network. The arrangement is suitable for the transmission of direct current, e.g. for buses, as well as for alternating current, e.g. for ferry applications.

According to the invention, a rocker with at least two contact rails is used to compensate for relative movements of the contact surfaces in the vertical direction, which rocker compensates for rolling movements of the vehicle during contact with roof-side contact surfaces. The invention is based on the fact that the vehicle-side contact surfaces are essentially rigid and, in this sense, are arranged in a fixed position on the vehicle. The contact rails of the charging device are adjusted according to the movement of the vehicle. For this purpose, the rocker according to the invention has a central, upright rocker support which carries a rocker beam. The rocker beam is mounted in a rocker beam bearing on the rocker support so that the rocker beam can rotate around a horizontal plane. The rocker support is located in a central vertical plane of the rocker and divides the rocker beam into two rocker levers on opposite sides of the vertical plane. A contact rail support is attached to each of the rocker levers. The fastening is done via upper pivot bearings, which can also be rotated in a horizontal plane. The contact rail supports each carry contact rails for contacting the electrical contact surfaces on the upper side of the vehicle. The contact rail supports are guided via guide members with respect to the rocker support. The guide members are in particular rods or struts which are connected on the one hand to the rocker support via a respective inner guide member bearing and on the other hand to the contact rail supports via a lower pivot bearing. These bearings also can be rotated in a horizontal plane. In this way, an oscillating lever is formed on each side of the vertical plane, with the rocker support forming the frame for one respective rocker lever and one guide member, with the rocker lever and the guide member guiding the contact rail support, which can be referred to as a coupling. The two four-bar linkages on either side of the vertical plane move in opposite directions due to the connection via the rocker beam. The arrangement of the pivot joints is particularly symmetrical with respect to the central vertical plane.

The particularity of the charging device according to the invention is that the distance between an upper pivot bearing and a lower pivot bearing of a contact rail support is significantly greater than the distance between the rocker beam bearing and the guide member bearings. In terms of a coupling mechanism, the distance between the bearing points on the frame is smaller than the length of the coupling. This ensures that the contact rail supports each follow the movement along a trajectory in which the contact rail supports are parallel to each other at most in the initial position, namely when the rocker beam is in a horizontal position, but are otherwise non-parallel to each other and change their angular position in relation to the vertical plane (x-z plane).

For example, if a bus is lowered on one side in the area of a bus stop, the contact surfaces on the roof are also inclined. A charging device with the rocker according to the invention, which is pressed against the contact surfaces, will follow the movement of the contact surfaces. According to the double lever principle, one of the rocker levers is lowered and the other rocker lever is raised. This pivoting leads to a displacement of the contact rail supports, whereby the lower end of the contact rail support which is displaced downwards is simultaneously displaced in the direction of the central vertical plane, namely additionally horizontally. The contact rail attached to the lower end of the contact rail support is thereby pivoted. The inner end of the contact rail, which is adjacent to the rocker support, is raised and the outer end is lowered. On the second rocker lever the situation is exactly the opposite. As a result, the angular position of the contact rails relative to the horizontal essentially corresponds to the angular position of the rocker beam. The inner end of the lowered contact rail, which was raised by the pivoting, is therefore at a greater distance from the vehicle roof. This reduces the risk of contact with the vehicle roof. Put simply, the contact rails are essentially parallel to the vehicle roof when the inclination of the vehicle changes due to rolling. It is hereby inherently accepted that the contact point of the contact rail with the electrical contact surface on the vehicle also shifts slightly horizontally and that the contact forces on the contact surfaces are not 100% identical, but these effects are subordinate to the advantage that larger rolling movements can be compensated. The advantages according to the invention arise in particular when the distance between the lower pivot bearing and the upper pivot bearing, namely the length of the coupling, is at least twice as large as the distance between the rocker beam bearing and the guide member bearings, namely the distance of the fixed bearings on the frame. The adjustment is even better if the distance is at least three times as large, especially 3.1 to 3.5 times.

Furthermore, it is advantageous if the guide member bearings are arranged at a horizontal distance from one another and are each located on one side of the vertical plane, wherein said distance is smaller than the distance between the rocker beam bearings and the guide member bearings. The invention is therefore based on the fact that the guide member bearings are not located in the region of the central vertical plane, but at a horizontal distance from the vertical plane. According to the invention, this distance does not have to be particularly large, but is preferably not larger and in particular equal to or smaller than the distance between the rocker beam bearing and the guide member bearing. Since the distance between the rocker beam bearing and the guide member bearing is less than half or less than a third of the distance between the pivot bearings, the horizontal distance between the guide member bearings is also comparatively small. Finally, in an advantageous development of the invention, it is provided that the distance between the pivot points of a contact rail support is greater than 70% of the distance between the contact rail and the upper pivot bearing. For example, the distance between the pivot points can be 140 mm, while the distance of the upper pivot point from the lower side of the contact rail is 195 mm. In this case the ratio of 0.72:1 results.

The charging device according to the invention is characterized primarily by the kinematics of the rocker. The charging device may well have more than one pair of contact rails for energy transmission, for example two pairs of contact rails, so that two contact rails are arranged on each contact rail support. These two rails on a contact rail support can themselves be pivoted relative to each other about a pivot axis, which is, however, at a 90° angle to the other axes of rotation mentioned above. These additional bearings can compensate for rolling movements around two axes.

The charging device according to the invention can be moved into the desired position in the horizontal and vertical directions via a support structure. The contact surfaces on the upper side of the vehicle are preferably also designed in the shape of rails or strips and run in particular transversely to the contact rails of the charging device. The contact is made in the node region of the vehicle-side contact surfaces and the charging device-side contact rails. The movement of the charging device to establish contact can take place pneumatically, hydraulically or electrically. Contact forces can be limited by springs or spring devices, in particular mechanical and/or pneumatic ones. The charging device is not limited to particular designs of supporting structures or kinematic principles or means of relative movement to the vehicle. The means for the relative movement of the charging device can be coupled to a positioning device which moves the charging device automatically, semi-automatically or by manual operation into the desired position with the aid of sensors and moves it out of this charging position again. The rocker may include means to hold the rocker beam in a zero position.

The charging device according to the invention is in particular a component of a stationary charging station for electrically powered vehicles, in particular watercraft, such as ferries, or also for land vehicles, such as electric buses.

In use, the charging device is moved relative to the electrical contact surface on the upper side of the vehicle and brought into contact with the contact surfaces. To compensate for vertical height shifts of the contact surfaces, a rocker with a central upright rocker support is brought close to the upper side of the vehicle in a central vertical plane in such a way that a rocker beam, which is rotatably mounted on a rocker beam bearing in a horizontal plane, is deflected in such a way that its two rocker levers, which are located on opposite sides of the vertical plane, are pivoted into the desired position. Each rocker lever has a contact rail support, which is also connected to the respective rocker lever via upper pivot bearings that can rotate in a horizontal plane. The contact rail supports each carry contact rails for contacting the contact surfaces. When a first contact surface, namely an upper or higher contact surface, is touched, the contact rail on the charging device-side is pushed upwards. The rocker arm is pivoted. At the same time, the contact rail on the other rocker lever is pressed downwards. Guide members are used to guide the contact rail support relative to the rocker support. The guide members are connected to the rocker support via the inner guide member bearing on the one hand and to the contact rail support via a lower pivot bearing on the other hand so that they can rotate in a horizontal plane. The distance between an upper pivot bearing and a lower pivot bearing of a contact rail support is selected to be larger than the distance between the rocker beam bearing and each of the guide member bearings. As a result, the individual contact rail supports are not moved parallel and are each at an acute angle to the central rocker support, which is arranged in particular upright, i.e. vertically. In the device according to the invention, the rocker support is not pivoted, but only the contact rail supports, which are at an angle to the rocker support. The contact rails attached to the contact rail supports are pivoted in the same way as the contact rail supports, in such a way that they are essentially parallel to the rocker beam. This reduces or eliminates the risk of the ends of the contact rails coming into contact with the vehicle roof when the vehicle performs a rolling movement. On the vehicle side, contact surfaces of lower height can be implemented without any loss of safety. The permissible total height of a vehicle, e.g. a bus, can be better utilized.

In the following, the invention will be described in greater detail with reference to exemplary embodiments illustrated in the schematic drawings. In particular

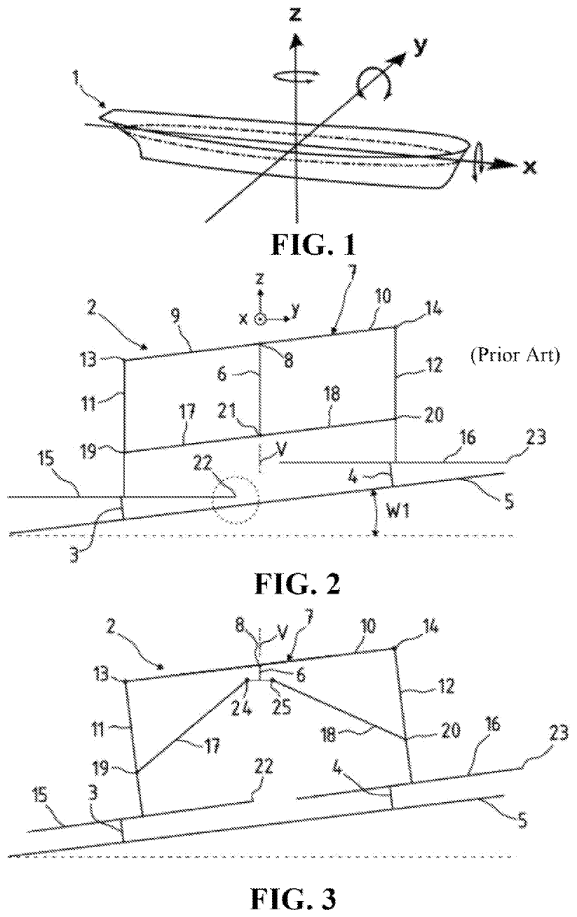

FIG. 1 shows a schematic representation of a vehicle;

FIG. 2 shows an embodiment of a charging device according to the prior art;

FIG. 3 shows a schematic representation of a charging device according to the invention and

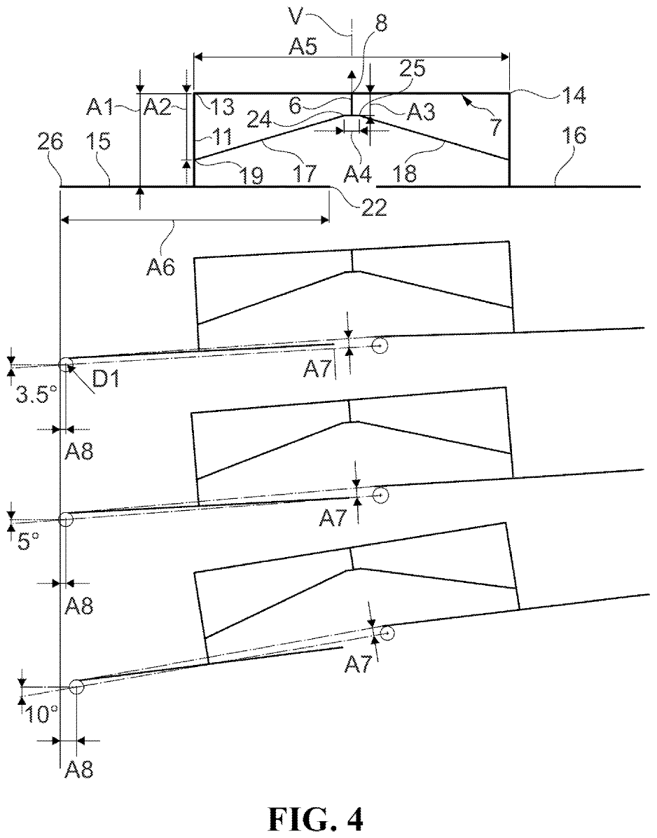

FIG. 4 shows the charging device of FIG. 3 in different positions.

FIG. 1 shows a vehicle 1, in this case a ship. The movements around the X-axis shown in the drawings are called rolling movements. They occur not only in watercraft due to weather conditions and charging, namely even when the watercraft is moored, but also in land vehicles, such as buses. In particular, buses are lowered on one side at stops to make boarding easier. In electric vehicles, such as ships or land vehicles, it is known to provide possibilities for coupling a charging device to the vehicle 1 for energy transfer on the upper side of the vehicle 1.

FIG. 2 shows a rocker 2 according to the prior art as a component of a charging device not shown in detail. The charging device has in particular electrical supply lines for energy transmission. In addition, the rocker is held on a support structure and can be brought into the desired position relative to the vehicle in order to connect it with electrical contact surfaces 3, 4 which, according to the example of FIG. 2, are attached to a roof 5 of the vehicle. The coordinate system of FIG. 1 was adopted into FIG. 2. It can be seen that the roof 5 is inclined by an angle W1 of e.g. 10°. This corresponds to a rolling movement around the X-axis. The electrical contact surfaces are contact rails that run in the X-direction, i.e. in the longitudinal direction of the vehicle. Due to the inclination by the angle W1 in the counterclockwise direction or the slanted position of the roof surface 5, a right contact surface 4 is at a higher level than the left contact surface 3 in the image plane. According to the prior art, it is known to use rockers to compensate for the different heights of the contact surfaces 4 caused by the rolling of the vehicle. The rocker 2 shown has a central rocker support 6, which is arranged essentially upright. The rocker support 6 is shown purely schematically. It can be attached to a supporting structure. The rocker support is brought into the desired position between the two contact surfaces 3, 4 above the roof 5. For contact or charging, the rocker support 6 is lowered until a first component of the rocker 2 touches the higher positioned contact surface 4. The rocker 2 has a rocker beam 7, which is mounted on the rocker support 6 so as to be rotatable in a horizontal plane via a rocker beam bearing 8. The rocker beam bearing 8 divides the rocker beam 7 into a left rocker lever 9 and a right rocker lever 10. Contact rail supports 11, 12 are arranged at the ends of the rocker levers 9, 10 or rocker beam 7. The contact rail supports 11, 12 and the rocker support are located in three planes parallel to each other, with the rocker support 6 being located in a central vertical plane V. The contact rail supports 11, 12 are each connected to the rocker beam 7 via upper pivot bearings 13, 14 so that they can also rotate about a horizontal plane. The contact rail supports 11, 12 each carry contact rails 15, 16 at their lower ends, which extend in the Y direction, namely essentially at right angles to the contact surfaces 3, 4. The contact rail supports 11, 12 are guided via guide members 17, 18. The guide members 17, 18 are connected to the contact rail supports 11, 12 via lower pivot bearings 19, 20 at a distance from the upper pivot bearings 13, 14 of the guide members. In addition, the guide members 17, 18 are connected to the rocker support 6 via a single central guide member bearing 21.

The upper pivot bearings 13, 14 have the same distance from the lower pivot bearings 19, 20 of the contact rail supports 11, 12 as the rocker beam bearing 8 has from the guide member bearing 21. The arrangement corresponds to a parallelogram. As a result, the contact rails 15, 16 will be displaced upwards and downwards in a horizontal position. When the roof 5 is inclined by the angle W 1, this causes the ends 22, 23 of the relatively long contact rails 15, 16 to get closer to the roof 5, as indicated by the circle shown. The angle W1 must therefore not be too large so that the contact rails 15, 16 do not fall below safety-relevant clearances and do not touch the roof 5.

FIG. 3 shows a charging device according to the invention. For functionally equivalent components, the same reference numerals are used as introduced in FIG. 2. The charging device of FIG. 3 again has a rocker 2 with a central, upright rocker support 6, which is arranged on a holding device in a manner not shown, in order to guide the charging device or the rocker 2 into the desired position relative to contact surfaces 3, 4 on the roof 5 of a vehicle, which is otherwise not shown in detail. The dashed line in FIG. 3 shows the horizontal plane. Just as in the embodiment of FIG. 3, the roof is inclined by the angle W1. This corresponds to rolling in the longitudinal direction of the vehicle. The rocker 2 has a rocker beam 7, which is centrally mounted in a rocker beam bearing 8. At its ends or the ends of the rocker levers 9, 10 on both sides of the rocker beam bearing 8 there are upper pivot bearings 13, 14, via which the contact rail supports 11, 12 are connected to the rocker beam 7 so as to be rotatable about a horizontal plane. In this embodiment, too, the contact rail supports are pivotally connected to the rocker support 6 via guide members 17, 18 about a horizontal axis via lower pivot bearings 19, 20. However, there are two separate guide members 17, 18 in the form of coupling rods, which are each connected to the rocker support 6 via their own guide member bearings 24, 25. The guide member bearings 24, 25 are arranged at a horizontal distance from each other. In addition, the two guide members 17, 18 are arranged at an angle of approximately 15° to the horizontal and thus to the rocker beam 7 in its initial position. The angle is relatively large, so that the guide members 17, 18 are not parallel to the rocker beam 7 in any position. As a result, the contact rail supports 11, 12 cannot move parallel to the rocker support 6. This results in contact rail supports 11, 12 being inclined in their longitudinal direction (y-direction in the initial position), i.e. they are at an angle other than 90° to the x-y-plane. The contact rails 15, 16 arranged at the ends of the contact rail supports 11, 12 follow this inclination with the result that the contact rails 15, 16 are arranged essentially parallel to the roof 5 of the vehicle. The ends 22, 23 of the contact rails 15, 16 are therefore at a greater distance from the roof than in the case of contact rails 15, 16, which always remain horizontal. With such a rocker 2, contact with the vehicle roof can be safely prevented. The rocker 2 can also be used for larger roll angles of the vehicle.

The distance between an upper pivot bearing 13, 14 and a lower pivot bearing 19, 20 of a contact rail support 11, 12 is greater than the vertical distance between the rocker beam bearing 8 and each of the guide member bearings 24, 25. Details can be found in the embodiment of FIG. 4.

FIG. 4 shows the rocker 2 of FIG. 3 in different positions. The four consecutive figures show the rocker 2 in a neutral starting position in which the rocker beam 7 is in a horizontal position. The following illustrations show the situation at 3.5°, 5° and 10° inclination of the roof of a vehicle not shown in detail.

The contact rail support 11 has a length A1 of 195 mm measured in the vertical direction, namely in the z-direction. The distance A2 between the upper pivot bearing 13 and the lower pivot bearing 19 is 140 mm, whereas the distance A3 between the rocker beam bearing 8 and the guide member bearing 24 is only 45 mm. In this embodiment, the rocker beam 7 has a length A5 of 669.5 mm. The horizontal distance A3 of the rocker support bearings 24, 25 is 30 mm. The contact rails 15, 16 each have a length A6 of 569 mm. In the initial position, the contact rails are arranged perpendicular to the central vertical axis V, i.e. horizontally. Due to the bilateral symmetry of the rocker, the upper and lower pivot bearings 13, 19 are located vertically one above the other in the initial position. The upper pivot bearings 13, 14 are at the same height, therefore the rocker beam 7 is arranged horizontally. Only the guide members 17, 18 are significantly inclined relative to the horizontal due to the very short rocker support 6, in particular by more than 10°, in particular 14 to 16°.

The following illustrations illustrate, on the one hand, that when the rocker 2 is deflected by 3.5°, 5° or 10°, the distance A8 of the outer end 26 of the contact rail 15 on the left in the image plane, which pivots downwards, increases from the initial position and is displaced in the direction of the central vertical plane V by the value A8. In each cross-section a circle with a diameter D1 of e.g. 30 mm is drawn. This circle indicates the outermost contact position with a contact surface on the roof of the vehicle. The invention entails that the value A8 increases slightly with increasing angle of inclination of the roof. With the proportions chosen here, the distance A8 is approx. 9 mm at 3.5°, approx. 14 mm at 5° and approx. 32 mm at 10°.

Furthermore, it can be seen that the right end 22 of the contact rail 15 in the image plane is arranged at a distance A7 to a plane running through the lower ends of the contact rail supports 11, 12, wherein the distance A7 increases with increasing deflection of the rocker. The distance A7 is approximately 10 mm at 3.5°, approximately 15 mm at 5° and approximately 28 mm at 10° deflection. If one compares these deflections with the exemplary embodiment of the prior art, it becomes clear that with a deflection of 10°, only a closing-in of 28 mm occurs, provided the dimensions are selected as in this embodiment. The closeness to the sloping roof would be much greater if kinematics were chosen as in the prior art. In particular, the closing-in remains smaller than 30 mm, and thus below the diameter D1, which in this example is 30 mm. With the same proportions, the closing-in distance of the design of the prior art would be 99 mm.

Since the rocker 2 cannot and should not achieve parallelism of the contact rail supports 11, 12 to the rocker support 8 due to the inclined guide members 17, 18, there is also no uniform distribution of force. However, the loss in terms of the uniformity of the contact force distribution is acceptable if it can ensure that the vehicle roof cannot be touched, even in the case of larger rolling movements of the vehicle. The rocker linkage according to the invention is therefore configured in such a way that when the linkage is deflected, the contact rail supports 11, 12 cannot be parallel, but rather an almost parallel positioning of the contact rails 15, 16 relative to the plane of the vehicle roof is specifically achieved.

The advantages according to the invention are particularly evident in the electrical charging of watercraft, in particular ferries, since larger rolling movements can also occur here due to loading and unloading and contact with the roof of the vehicle cannot be ruled out during larger rolling movements if the rocker is not configured accordingly.

### REFERENCE NUMERALS

1—vehicle
2—rocker
3—contact surface at 5
4—contact surface at 5
5—roof of 1
6—rocker support
7—rocker beam
8—rocker beam bearing
9—rocker lever of 7
10—rocker lever of 7
11—contact rail support
12—contact rail support
13—upper pivot bearing
14—upper pivot bearing
15—contact rail
16—contact rail
17—guide member
18—guide member
19—lower pivot bearing
20—lower pivot bearing
21—guide member bearing
22—end of 15
23—end of 16
24—guide member bearing
25—guide member bearing
26—end of 15
A1—length of 11
A2—distance between 13 and 19
A3—distance between 8 and 24, 25
A4—horizontal distance between 24 and 25
A5—length of 7
A6—length of 15, 16
A7—distance of 22
A8—distance of 26
D1—diameter of 3 and
V—vertical plane

1. A charging device for electric vehicles having a rocker which is movable relative to electrical contact surfaces, on an upper side of the vehicle,
wherein the rocker has a central upright rocker support (6) in a central vertical plane with a rocker beam bearing,
wherein the rocker has a rocker beam which is centrally and rotatably mounted in a rocker beam bearing,
wherein the rocker beam has two rocker levers on opposite sides of the vertical plane,
wherein upper pivot bearings are located at the ends of the rocker levers,
wherein contact rail supports are connected to the rocker levers via the upper pivot bearings,
wherein the contact rail supports each carry contact rails
wherein the contact rail supports are pivotally connected to the rocker support (6), wherein the connection is provided via lower pivot bearings which can be rotated about a horizontal axis,
characterized in that
the contact rail supports are pivotally connected to the rocker support via separate guide members,
wherein the guide members are each connected to the contact rail support via an inner guide member bearing,
wherein each four-bar linkage consists of an upper pivot bearing a lower pivot bearing, an inner guide member bearing and the rocker beam bearing, wherein the two four-bar linkages on either side of the vertical plane move in opposite directions due to the connection via the rocker beam,
wherein a distance between an upper pivot bearing and a lower pivot bearing of a contact rail support is greater than a distance between the rocker beam bearing and each of the guide member bearings.

2. The charging device according to claim 1, wherein the distance between the upper pivot bearing and the lower pivot bearing is at least twice as large as the distance between the rocker beam bearing and the guide member bearings.

3. The charging device according to claim 1, wherein the distance between the upper pivot bearing and the lower pivot bearing is at least three times as large as the distance between the rocker beam bearing and the guide member bearings.

4. The charging device according to claim 1, wherein the guide member bearings are arranged at a horizontal distance from one another and are each located on one side of the vertical plane, wherein said distance is smaller than the distance between the rocker beam bearing and the guide member bearings.

5. The charging device according to, wherein the distance of the pivot points of a contact rail support is greater than 70% of a distance of the contact rail from the upper pivot bearing.
